(19) United States
(12) Patent Application Publication
(10) Pub. No.: US 2007/0174054 A1
(43) Pub. Date: Jul. 26, 2007

(54) COMMUNICATION APPARATUS WITH SIGNAL MODE AND VOICE MODE

(75) Inventors: Hsing-Fei Lee, Taoyuan Hsien (TW); Hsi-Wen Nien, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/612,817

(22) Filed: Dec. 19, 2006

Related U.S. Application Data
(60) Provisional application No. 60/761,992, filed on Jan. 25, 2006.

(51) Int. Cl. G10L 15/06

(52) U.S. Cl. 704/243

(57) ABSTRACT

A communication apparatus operates under a voice mode or a signal mode has a demodulator, a modifier, a decoder, an error concealment unit and a synthesizer. The demodulator demodulates a received signal to generate a data frame and an original code word. If the communication apparatus is operated under the signal mode and the original control word indicates that the data frame is one bad frame, the modifier generates a processed control word that indicates that the data frame is one good frame. The error concealment unit determines whether to perform an error concealment on the data frame depending on the processed control word. The synthesizer receives code data derived by the data frame by the decoder or error-concealed data from the error concealment unit to generate a voice output.

### CROSS REFERENCE TO RELATED APPILCATIONS

This application claims the benefit of U.S. Provisional Application No. 60/761,992, filed Jan. 25, 2006.

### BACKGROUND OF THE INVENTION

1. Field of the Invention

The invention relates to voice communication, and in particular, to text communication over voice communication systems.

2. Description of the Related Art

FIG. 1 shows a conventional voice communication system, representing a typical mobile phone system such as 3GPP or GSM. Sound input is encoded and transmitted as an RF signal comprising a consecutive frame stream. The voice communication system includes an antenna 102, a modem demodulator 110, a decoder 130, an error concealment unit 120, a voice synthesizer 140. The demodulator 110 receives and demodulates the transmitted RF signal to obtain a data frame #frame, and identifies attributes of the data frame #frame to generate a control word #ctrl. According to digital cellular communication standards such as GSM, a frame is a time interval of 20 ms, and 160 samples at an 8 kHz sampling rate may be transmitted thereby. Voice data may be encoded using Algebraic Code Excited Linear Prediction (ACELP) models into various parameters such as LP filter coefficients, adaptive and fixed codebooks' indices and gain values. Data in a data frame #frame may be corrupt while transmitting through the channel, thus the demodulator 110 checks the data frame #frame and writes corresponding attributes in the control word #ctrl, such as a quality indicator or a frame type indicator. An error concealment unit 120 is coupled to the demodulator 110 and performs error concealment if the control word #ctrl indicates that the associated data frame is corrupt frame, bad or no data Otherwise, if the control frame indicates that the data frame is a good frame, the error concealment is not enabled. A decoder 130 is coupled to the modem demodulator 110, extracting the data frame #frame to obtain parameters such as gain value #gain and codeword #code. A voice synthesizer 140 coupled to the decoder 130 includes an exercitation unit 142, e.g. a codebook unit, an amplifier 144 and an linear prediction synthesis filter (LP synthesis filter) 146. The voice synthesizer 140 synthesizes the codeword #code to generate an output signal #out based on the gain value #gain. If the error concealment unit 120 is enabled, the synthesizer 140 does not decode the codeword #code, and instead, substitution parameters may be provided to render the output signal #out. Various implementations of error concealment have been proposed, thus detailed description is not introduced. In some cases, the voice communication system may be used to transmit text data. For example, a cellular text telephone modem (CTM) transmits text data by signal tones. When a text type data frame #frame comprising signal tones is received, the modem demodulator 110 may identify it as a corrupt frame, and the error concealment unit 120 is enabled to suppress the signal tones from output. Thus, text data transmission may encounter incompatibility problems when used in the voice communication device, and an improvement is desirable.

### BRIEF SUMMARY OF THE INVENTION

A preferred embodiment according to the invention is a communication apparatus, e.g. a GSM mobile phone support CTM mode. The communication apparatus operates under a voice mode or a signal mode, e.g. CTM mode, and has a demodulator, a modifier, a decoder, an error concealment unit and a voice synthesizer. The demodulator demodulates a received signal to generate a data frame and an original code word. If the communication apparatus is operated under the signal mode and the original control word indicates that the data frame is one corrupt frame, the modifier generates a processed control word that indicates that the data frame is one good frame. The error concealment unit determines whether to perform error concealment on the data frame depending on the processed control word. Therefore, if the operation mode is the signal mode and a corrupt data frame is received, the processed control word indicates a “good” data frame, instead of a “bad” data frame is received. Such modification will suppress the operation of the error concealment unit under the signal mode. Moreover, the synthesizer receives code data derived by the data frame by the decoder or error-concealed data from the error concealment unit to generate a voice output.

An enhancement to the communication apparatus is to provide a gain limiter in the voice synthesizer for controlling gain values provided by the decoder under the signal mode. With the gain limiter, when voice data are synthesized under the signal mode, a limited gain value is guaranteed so that the output of the voice synthesizer is under desired range.

With the invention, a communication apparatus can use one set of circuits to support both voice mode and signal mode under a desired performance output.

Another embodiment provides a communication method implemented using the voice communication system, and a detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional voice communication system;

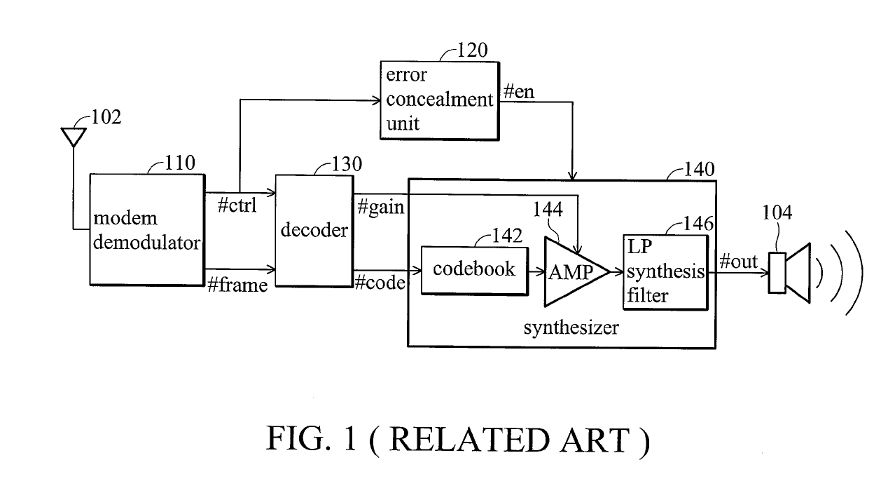

FIG. 2 shows an embodiment of a communication system comprising a modifier 210; and

FIG. 3 is a flowchart of a voice communication method based on the communication system in FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

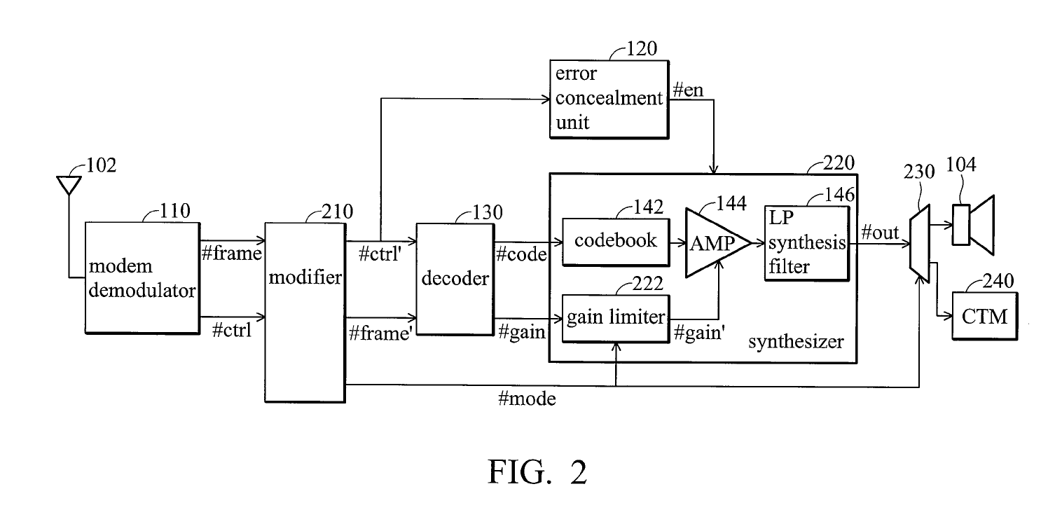

FIG. 2 shows an embodiment of a communication apparatus operating under one of at least the two modes, conventional voice communication mode, and a signal mode. Examples of the signal mode include text data transmission mode like CTM mode in GSM standard. The communication apparatus has an antenna 102, a demodulator 110, a modifier 210, a decoder 130, an error concealment unit 120, a voice synthesizer 220, a demultiplexer 270, a mode switch 270, a speaker 104 and a signal output device 280.

The demodulator 110 receives a RF signal from the antenna 102 and generates a series of data frame and associated original control words. One original control word indicates whether its associated data frame is a good data frame or a corrupt data frame by analyzing its signal characteristics and quality. The original control word is transmitted to the modifier 210 for generating a processed control word.

The modifier 210 is coupled to a mode switcher 270. If the mode switcher 270 indicates that the communication apparatus is operated under the signal mode and the modifier 210 finds that the original control word indicates a corrupt frame, the modifier 210 outputs a processed control word marked as a “good” frame. If the modifier finds that the original control word indicates a good frame, the modifier outputs a processed control word marked as a “good” frame, too. If the communication apparatus is operated under the voice mode, the modifier just sets the processed control word the same as the original control word.

The error concealment unit 120 receives the data frame and the processed control word. If the control word indicates that the received data frame is a “bad or no data” frame, the error concealment unit 120 performs error concealment processing. Otherwise, the error concealment unit 120 is not enabled.

Next, the decoder 130 receives the data frame and the processed control word and generates a code data and a gain value to the voice synthesizer 220. The voice synthesizer 220 has a exercitation unit 142, a gain limiter 222, an amplifier 144 and a linear prediction synthesizer filter 146. The exercitation unit 142 is used for exercising the received code data to turn the code data into corresponding voice information. Under CELP in GSM standard, there are two types of the exercitation unit 142. One is adaptive codebook unit that maps a code data to associated voice information and the other is a fixed codebook unit that maps a code data to associated voice information. The exercitation unit 142 provides output to the amplifier 144 and then the linear prediction synthesizer filter 146 to generate a voice output.

In addition to the input from the exercitation unit 142, the amplifier also receives a limited gain value from the gain limiter 222. The gain limiter receives the original control word to know whether the processing data to be amplified is a good or a corrupt data frame. If the processing data to be amplified is a “bad or no data” data frame according to its original control word and the operating mode is the signal mode, the gain limiter 22 limits the gain value received from the decoder so that the amplified results of the amplifier 144 does not exceed a desired range. If the gain limiter is under the operating mode of the voice mode or finds that the original control word indicates a good data frame, the gain limiter just forwards the gain value to the amplifier 144.

When the voice output is generated by the voice synthesizer, the demultiplexer directs the voice output to the speaker 104 if the communication apparatus is under the voice mode and directs the voice output to the signal output device 280 if the communication apparatus is under the signal mode. An example of the signal output device 280 is a display capable of showing text or graphical images.

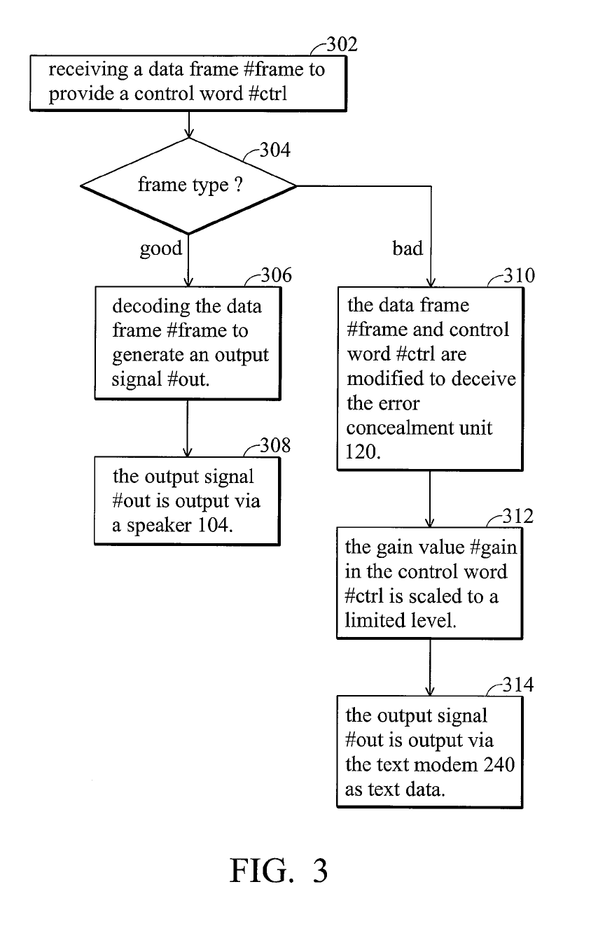

FIG. 3 is a flowchart of a voice communication method based on the communication system in FIG. 2. In step 302, an RF signal is demodulated to a data frame #frame, and an original control word #ctrl is generated by analyzing the data frame #frame. In step 304, the original control word of the data frame #frame is determined. If the data frame #frame is a good frame, step 306 is processed, decoding the data frame #frame to generate an output signal #out. Thereafter, in step 308, the output signal #out is output via a speaker 104. Otherwise, if the frame type is determined to be a corrupt frame in step 304, step 310 is processed and the data frame #frame and control word #ctrl are modified to deceive the error concealment unit 120. In step 312, the gain value #gain in the control word #ctrl is scaled to a limited level. In step 314, the output signal #out is output via the text modem 240 as text data. This disclosure can be specifically applied in a CTM system utilizing current voice communication devices such as a mobile phone or telephone.

In other embodiments, the frame type in the control word #ctrl may not be the only way to identify a frame type. A text type frame may comprise a specific parameter to indicate its mode, and the modifier 210 may determine the #mode by identifying the specific parameter. In this way, a corrupt voice frame can be distinguished from a text type frame, and the error concealment unit 120 may be enabled when a corrupt voice frame is identified. Thus, only text frames are modified to avoid being suppressed by the error concealment unit 120.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication apparatus having a signal mode and a voice mode, comprising:
a demodulator for demodulating a received signal to generate a data frame and an original control word, the original control word indicating a status of the data frame;
a modifier coupled to the demodulator for receiving the original control word to generate a processed control word, wherein if the communication apparatus is in the signal mode and the original control word indicates that the data frame is one corrupt data frame, bad or no data, the modifier sets the processed control word to indicate that the data frame is one good data frame;
an error concealment unit coupled to the modifier to receive the data frame and the processed control word to generated an error-concealed data if the processed control word indicates that the data frame is one corrupt frame;
a decoder coupled to the modifier for decoding the data frame to generate a data code;
a voice synthesizer coupled to the decoder, wherein if the processed control word indicates that the data frame is a one good frame, the voice synthesizer generates a first voice output according to the data code; and if the processed control word indicates that the data frame is one corrupt frame, the voice synthesizer generates a second voice output according to the error-concealed data.

2. The communication apparatus of claim 1, wherein the signal mode is a CTM mode.

3. The communication apparatus of claim 1, further comprising:
a mode switcher coupled to the modifier for switching the communication apparatus between the signal mode and the voice mode.

4. The communication apparatus of claim 1, wherein the voice synthesizer comprises an exercitation unit and a gain limiter, the exercitation unit receiving the data code for generating an excited data and the gain limiter receiving a gain value from the decoder and generating a limited gain value.

5. The communication apparatus of claim 4, wherein the voice synthesizer further comprises an amplifier for amplifying excited data according to the limited gain value if the original control word indicates that the data frame is one corrupt data frame.

6. The communication apparatus of claim 5, wherein the exercitation unit is a codebook unit.

7. The communication apparatus of claim 6, wherein the codebook unit is an adapted codebook unit.

8. The communication apparatus of claim 6, wherein the codebook unit is a fixed codebook unit.

9. The communication apparatus of claim 6, wherein the communication apparatus is a GSM mobile phone with CTM mode.

10. The communication apparatus of claim 1, wherein in the signal mode, the received signal carries non-voice information that is encoded into a corresponding voice.
